(19) United States
(12) Patent Application Publication
(10) Pub. No.: US 2017/0168597 A1
(43) Pub. Date: Jun. 15, 2017

(54) PEN HOVER RANGE

(71) Applicant: Lenovo (Singapore) Pte. Ltd., Singapore (SG)

(72) Inventors: John Weldon Nicholson, Cary, NC (US); Scott Edwards Kelso, Cary, NC (US)

(21) Appl. No.: 14/964,286

(22) Filed: Dec. 9, 2015

(51) Int. Cl. G06F 3/0354; G06F 3/041

(52) U.S. Cl. CPC G06F 3/03545; G06F 3/0416; H04B 7/24

(57) ABSTRACT

One embodiment provides a method, including: identifying, using a processor, a location of a user input device relative to an input surface; detecting, using a sensor, that the user input device has moved a predetermined distance from the input surface; receiving, using at least one other sensor, movement data of the user input device; and modifying, based on the movement data, the identified location of the user input device relative to the input surface. Other aspects are described and claimed.

### BACKGROUND

Information handling devices (“devices”), for example cell phones, smart phones, tablet devices, laptop computers, and the like permit users to input handwriting or pointer input using a mouse or pen/stylus. Utilizing a pen or stylus allows a user to write in a more natural way and without the use of a keyboard.

Conventionally a handwriting field, box or pane may be presented to the user as on a touch screen display for entering handwriting input. Alternatively, an application or device interface may support handwriting input generally (i.e., the handwriting input is not restricted to a particular area). A variety of touch sensitive surfaces exist, each with their own benefits and draw backs. Using these touch sensitive devices, a user may provide input handwriting input or strokes, e.g., letters, numbers, characters, symbols, etc. The device will typically employ some kind of software that uses the input handwriting strokes. These strokes are generally presented on screen to provide visual feedback to the user, as input by converting the handwriting input locations on the touch screen into image data or text. Additionally, the input may be used to select an object or interact with an application or operating system via a cursor or like tool. A graphic representation of the handwriting or cursor may be visible within an underlying application or operating system.

### BRIEF SUMMARY

In summary, one aspect provides a method, comprising: identifying, using a processor, a location of a user input device relative to an input surface; detecting, using a sensor, that the user input device has moved a predetermined distance from the input surface; receiving, using at least one other sensor, movement data of the user input device; and modifying, based on the movement data, the identified location of the user input device relative to the input surface.

Another aspect provides a system, comprising: an input surface; a processor operatively coupled to the input surface; and a memory device that stores instructions executable by a processor to: identify a location of a user input device relative to the input surface; detect that the user input device has moved a predetermined distance from the input surface; receive movement data of the user input device; and modify, based on the movement data, the identified location of the user input device relative to the input surface.

A further aspect provides a product, comprising: a storage device having code stored therewith, the code being executable by a processor and comprising: code that identifies a location of a user input device relative to an input surface; code that detects, using a sensor, that the user input device has moved a predetermined distance from the input surface; code that receives movement data of the user input device; and code that modifies, based on the movement data, the identified location of the user input device relative to the input surface.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of improving pen hover range.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As technology improves, it continues to adapt and adjust to create a more comfortable means of user interaction. For example, many devices now accept voice input and handwriting input as a form of user input. However, more improvement is needed to create a fluid and intuitive user experience. Currently, mobile devices (e.g., smart phones, tablets, etc.) allow users to enter touch input in a variety of ways, using a variety of technologies. The currently available technologies for pen input however are limited in that the user must have the pen physically touching the touch device, or extremely close (within a hover range).

The general hover range of a stylus/pen is small (e.g., 10 mm) using today's technology. Although this is likely to improve in the future, the current outlook is that the hover range may only be extended up to 20 or 30 mm. This is still a very limiting range and can be inconvenient for a user, e.g., if the user is attempting to present information to other users, which may require the user to stand back some distance from the device (i.e., to allow others visible access). Thus, a solution is needed to allow a user to interact with a device (e.g., touch device) using a user input device (e.g., stylus or mouse) while being a reasonable distance away from the device. Further, the user experience should be fluid and allow a user to go from writing directly on the input surface to inputting data from a reasonable presenting distance (e.g., 5 ft, 30 ft, etc.).

This technical issue presents problems for a user because as they interact with a touch surface, specifically in a presentation mode, they may need access to the device when not within arm's reach of the device. Thus, an embodiment is more convenient in many scenarios, e.g., when a user is giving a presentation. Allowing a user to manipulate a device at a distance (e.g., select objects, enter handwriting input, etc.) further increases the usability of the device and adds an increased accuracy.

Accordingly, an embodiment provides a method of identifying a location of a user input device relative to an input surface, e.g., recognizing a stylus is in contact with a touch surface and allowing for a user to enter input via the stylus. An embodiment may then detect that the user input device has moved away from the touch surface (e.g., out of hover range (10 mm-30 mm)). Based on this detection, an embodiment may make use of additional sensors (e.g., accelerometer, compass, etc.) within the user input device, input surface, etc., to determine the input device location relative to the input surface. Thus, an embodiment may detect where the user is attempting to enter input on the touch surface based on the direction the stylus is pointed. Using this modified location data, an embodiment may receive user input via the user input device (e.g., stylus) when the stylus is not in contact with the touch surface, or even a large distance away form the touch surface.

The illustrated example embodiments will be best understood by reference to the figures. The following description is intended only by way of example, and simply illustrates certain example embodiments.

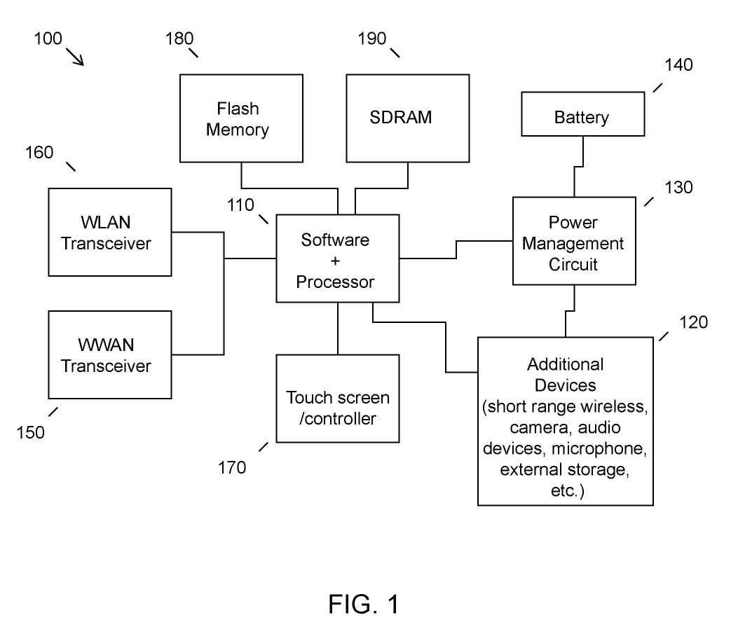

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor (e.g., a camera), a short range wireless device for communicating with other devices (e.g., pen, stylus, etc.) and the like. System 100 often includes a touch screen 170 for data input and display/rendering. System 100 also typically includes various memory devices, for example flash memory 180 and SDRAM 190.

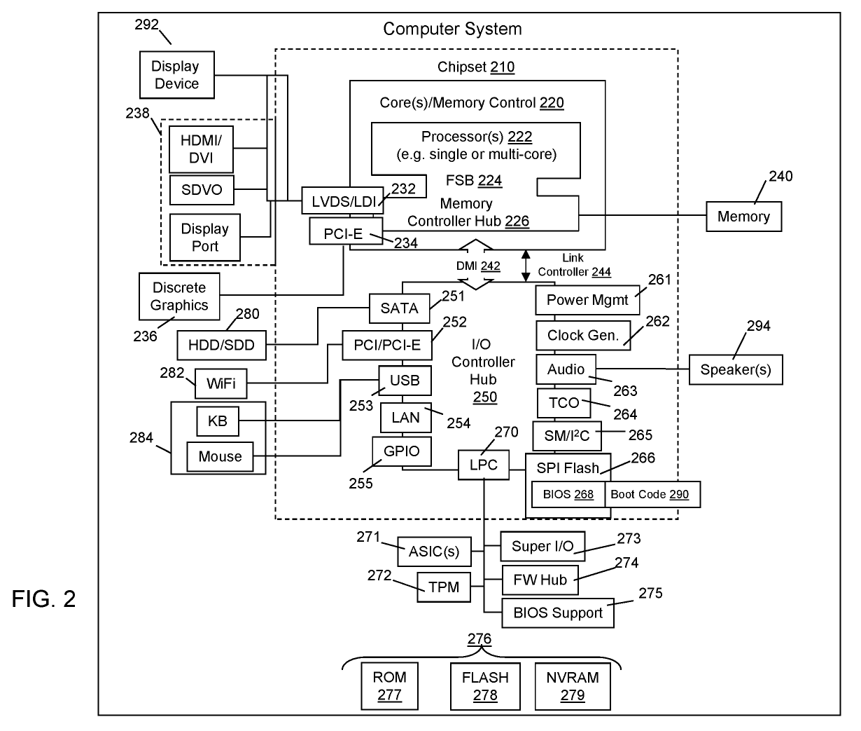

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or other electronic devices, with which users may interact using a pen or stylus. For example, the circuitry outlined in FIG. 1 may be implemented in a tablet or smart phone embodiment, whereas the circuitry outlined in FIG. 2 may be implemented in a personal computer embodiment.

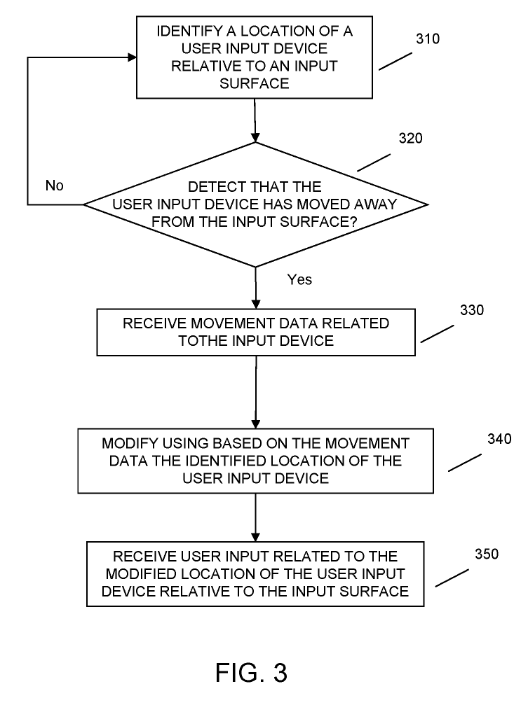

Referring now to FIG. 3, an embodiment may identify a location of a user input device relative to an input surface at 310. The user input device may be for example a stylus or pen used to interact with the input surface. The user input device may operate according to one or more of a variety of technology types (e.g., active pen/digitizer, capacitive input surface with active pen/stylus, positional pen/stylus, camera or optical enabled pen/stylus, trackball technology, etc.). The input surface may be for example a touch sensitive surface (e.g., resistive touch screen, capacitive touch screen, surface acoustic wave touch screen, infrared touch screen, optical imaging touch screen, etc.), i.e., the input surface may participate in a passive or active in nature to accept inputs of a user input device such as a pen or stylus.

When the user input device (e.g., stylus) is within-range of the input surface (e.g., touch screen/digitizer sensor), an embodiment uses the touch surface to identify the position the cursor (e.g., where the stylus is directed) at 310. An embodiment continues to determine the user input device location via the touch surface, until it is detected that the user input device has moved away from the input surface a predetermined distance (e.g., 10 mm, 20 mm, 30 mm etc.) at 320. For example, an embodiment may only have a hover range of 10 mm. Thus, when the stylus has been moved further than 10 mm from the input surface, thereby causing the stylus to no longer be sensed directly, an embodiment may then identify that the user input device has moved away from the touch surface at 320.

Once it determined the user input device has moved away from the touch surface, an embodiment may determine the user input device location relative to the input surface using another activated sensor(s) at 330. Thus, an embodiment may activate a single or multiple sensors within the input surface, the user input device, and/or another device (e.g., having a sensor that communicates to a device including the touch sensitive surface). For example, sensors such as: an accelerometer, a gravity sensor, a gyroscope, a rotational vector sensor, an orientation sensor, an infrared sensor, an optical sensor, and/or a magnetometer may be utilized to determine the location of the user input device relative to the input surface. A user input device such as stylus may have an accelerometer that can detect the movement of the stylus. Thus, an embodiment may combine the snapshot of location knowledge obtained when the stylus was in hover range with the real time data acquired from an accelerometer (e.g., facilitated by short range wireless communication between the stylus and an electronic device housing the input surface) to determine a new location of the user input device relative to the touch surface.

Additionally or alternatively, sensor(s) may be activated on the input surface. The sensors may work cooperatively or independently from one another. For example, an optical capture device (e.g., a camera) may be activated on or in relation to the input surface. The optical device may then be used by an embodiment to determine the location of the user input device relative to the touch surface.

Once a sensor or plurality of sensors has been activated, the location of the user input device relative to the input surface is modified at 340 (e.g., from its last known location as identified at 310) as the user moves one device (e.g., the user input device or the input surface device) relative to the other device device. For example, if the user input device is moved away from the touch surface and also to the right, the additional sensor(s) would detect the rightward movement and modify the previously identified location based on the detected movement. As an alternative example, a user may move the input surface device away and to the right of the input device, and the sensor(s) would detect the movement and modify the previously identified location. Visual display may be provided regarding the modified location, e.g., to keep a user apprised of the currently identified location of the user input device relative to the surface.

In an embodiment, the modified location may take into account physical characteristics of the user input device, e.g., modifying the location of the user input device relative to the input surface as a point projected along a long axis of the stylus, e.g., as if a ray were projecting from the tip of the stylus. For example, if a user is presenting a slide show to co-workers, the user may use the user input device (e.g., stylus, mouse, etc.) to draw (while touching the input surface) a circle around a point of interest on the screen. The user may then subsequently move the input device away from the input surface, while still using the modified location to select objects based on the direction the input device is pointing (e.g., a ray based on the tip of the stylus). The stylus may function as a pointer or selection tool based on the additional sensor(s) tracking the stylus as the user moves it with respect to the input surface. The direction of the tip of the stylus with respect to the input surface in this example is used to determine the intended location.

In an embodiment, the orientation of the user input device may be determined and tracked. An embodiment may obtain movement related data from the activated sensor(s) and extract any angular motion along the three angular axes (e.g., x, y, and z). Based on the orientation of the user input device, an embodiment can more accurately determine where the user intends the user device input to be relative to the input surface. The orientation of the input user device may be used for various purposes, e.g., to deactivate a sensor (e.g., the touch sensor), even when within hover range. For example, if a user rests a stylus upon a tablet, an embodiment may sense the orientation of the stylus is directly perpendicular to the touch surface of the tablet, and thus disable the active or passive touch input between the stylus and tablet.

Therefore, an embodiment enables detection of extreme orientation differences even when inside hover-range. In the above discussed example (i.e., the pen resting on the surface of the screen), the input surface (e.g., digitizer) will typically sense the position of the tip of the pen and place the mouse cursor underneath it, even though the orientation of the stylus dictates that it is not being used as such, i.e., the pen tip never intersects the screen, but rather lies parallel thereto. Thus, an embodiment may utilize the orientation information to detect this situation, e.g., to not set the cursor position.

After the user input device has moved away from the touch surface, and the modified location is determined using the additional sensors, as illustrated at 320 and 330 of FIG. 3, an embodiment may receive user input related to the modified location at 350. This user input may be in the form of selecting an object displayed on the touch surface, entering handwriting input, or any function capable of being completed using a stylus/mouse input method.

Although the additional sensors allow for a high level of accuracy, it may be possible for the location detection of the user input device to include errors, e.g., after prolonged use away from the touch surface. Although the orientation estimate is robust for long periods of time (because the magnetic and gravitational fields of the Earth are slow changing), an embodiment may identify outliers (e.g., if multiple sensors are used) in the sensor array and filter out the noise from faulty sensor data. Thus, when an embodiment senses that the user input device (e.g., stylus) is in contact with the input surface (e.g., touch screen), for example through the pressure level reported by a stylus, all positioning offset due to orientation estimate is removed.

Nonetheless, due to the accumulation of errors regarding the additional sensor(s), an embodiment may re-calibrate the location of the user input device when it reenters the hover range of the input surface. Thus, when an input device reenters the hover range of the input surface after being outside of the range, an embodiment may identify a location similar to that of step 310, wherein the location is based on the interaction of the user input device and the input surface as discussed herein (e.g., active digitizer, capacitive, positional, camera, trackball, resistive touch screen, capacitive touch screen, surface acoustic wave touch screen, infrared touch screen, optical imaging touch screen, etc.).

In order for the user input device and the input surface to transition smoothly between sensing methods, an embodiment may use a form of wireless communication between the user input device and the input surface (e.g., wireless LAN, wireless WAN, near field communication, short range wireless communication, etc.) to communicate the current state of the various sensors.

Accordingly, described herein thus represent a technical improvement to identifying a location of a user input device relative to an input surface. If the user input device is moved away from the input surface (e.g., out of hover range), an embodiment may receive movement data from at least one additional sensor. Then, based on the additional sensor data, an embodiment may detect and identify the movement of the user input device relative to the input surface. Based on the newly identified location, an embodiment may receive user input associated with the determined location of the user input device. The various embodiments illustrated herein, may also be recalibrated when the user input device reenters the hover range of the input surface.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
identifying, using a processor, a location of a user input device relative to an input surface;
detecting, using a sensor, that the user input device has moved a predetermined distance from the input surface;
receiving, using at least one other sensor, movement data of the user input device; and
modifying, based on the movement data, the identified location of the user input device relative to the input surface.

2. The method of claim 1, wherein the input surface comprises a touch sensitive surface.

3. The method of claim 2, wherein the touch surface comprises at least one of:
passive and active.

4. The method of claim 1, wherein the user input device comprises a stylus.

5. The method of claim 1, wherein the at least one other sensor is selected from the group consisting of: an accelerometer, a gravity sensor, a gyroscope, a rotational vector sensor, an orientation sensor, an infrared sensor, an optical sensor, and a magnetometer.

6. The method of claim 1, further comprising identifying, using the at least one other sensor, an orientation of the user input device.

7. The method of claim 6, wherein the receiving user input is disabled if the orientation of the user input device exceeds a predetermined threshold.

8. The method of claim 1, further comprising detecting, using the sensor, that the user input device has reentered the predetermined distance from the input surface.

9. The method of claim 8, further comprising responsive to the user input device reentering the predetermined distance, calibrating the at least one other sensor based on the location determined by the sensor.

10. The method of claim 1, wherein the user input device and the input surface communicate via a wireless communication protocol.

11. A system, comprising:
an input surface;
a processor operatively coupled to the input surface; and
a memory device that stores instructions executable by a processor to:
identify a location of a user input device relative to the input surface;
detect that the user input device has moved a predetermined distance from the input surface;
receive movement data of the user input device; and
modify, based on the movement data, the identified location of the user input device relative to the input surface.

12. The system of claim 11, wherein the input surface comprises a touch sensitive surface; and.
wherein the touch surface comprises at least one of: passive and active.

13. The system of claim 11, wherein the user input device comprises a stylus.

14. The system of claim 11, wherein the at least one other sensor is selected from the group consisting of of: an accelerometer, a gravity sensor, a gyroscope, a rotational vector sensor, an orientation sensor, an infrared sensor, an optical sensor, and a magnetometer.

15. The system of claim 11, further comprising identifying, using the at least one other sensor, an orientation of the user input device.

16. The system of claim 15, wherein the receiving user input is disabled if the orientation of the user input device exceeds a predetermined threshold.

17. The system of claim 11, further comprising detecting, using the sensor, that the user input device has reentered the predetermined distance from the input surface.

18. The system of claim 17, further comprising responsive to the user input device reentering the predetermined distance, calibrating the at least one other sensor based on the location determined by the sensor.

19. The system of claim 11, wherein the user input device and the input surface communicate via a wireless communication protocol.

20. A product, comprising:
a storage device having code stored therewith, the code being executable by a processor and comprising:
code that identifies a location of a user input device relative to an input surface;
code that detects, using a sensor, that the user input device has moved a predetermined distance from the input surface;
code that receives movement data of the user input device; and
code that modifies, based on the movement data, the identified location of the user input device relative to the input surface.
